(19) United States
(12) Patent Application Publication
(10) Pub. No.: US 2026/0328463 A1
(43) Pub. Date: Oct. 22, 2026

(54) ALL-IN-ONE PORTABLE HOUSEHOLD APPLIANCE FOR COOKING, COOLING, AND CHARGING

(71) Applicant: Barefoot Citizens IP Pty Ltd, Morningside (AU)

(72) Inventors: Simon James DOBLE, Brisbane (AU); Brendan Hingston LAKE, Lennox Head (AU); Douglas Findlay Stirling CHAMLEY, Cambridge (GB); Ryan John DUNWOODY, Glossop (GB)

(73) Assignee: Barefoot Citizens IP Pty Ltd, Morningside (AU)

(21) Appl. No.: 19/566,045

(22) Filed: Mar. 13, 2026

Related U.S. Application Data
(60) Provisional application No. 63/772,275, filed on Mar. 14, 2025.

(51) Int. Cl. F25D 3/08; H05B 6/06; H05B 6/12

(52) U.S. Cl. CPC F25D 3/08; H05B 6/062; H05B 6/1209; F25D 2300/00; F25D 2331/804; F25D 2400/02; F25D 2400/12

(57) ABSTRACT

A portable household appliance includes a housing containing an induction cooktop, a cooler, a charging unit comprising at least one outlet configured for powering other household devices, and a battery configured for powering the induction cooktop, the cooler, and the charging unit, wherein the portable household appliance is configured to be carried by one or two people. The appliance may include a telemetry system with multi-mode communication capability (NB-IoT and LoRaWAN) for collecting and transmitting usage data to enable carbon credit verification. The multi-function nature of the appliance creates a multi-dimensional usage signature that provides richer evidence for verification and is more difficult to falsify than single-purpose devices.

### CROSS-REFERENCE TO RELATED APPLICATIONS

This application claims priority to and the benefit of U.S. Provisional Application No. 63/772,275, filed Mar. 14, 2025, the contents of which are incorporated herein in its entirety.

### FIELD OF INVENTION

This application relates generally to household appliances, and more particularly to all-in-one portable household appliances for cooking, cooling, and charging that are powered by solar energy.

### BACKGROUND

Many regions lack reliable access to electrical infrastructure and household energy resources. Limited access to electricity restricts the availability of essential appliances for cooking, food preservation, lighting, and charging portable electronic devices. As a result, households often rely on inefficient or hazardous alternatives, such as solid-fuel cooking devices or the absence of refrigeration, which can contribute to health, environmental, and economic challenges. Existing solutions typically address cooking, cooling, and device charging as separate single-purpose systems, each requiring independent power sources and maintenance. This fragmented approach increases cost, complexity, and logistical burden, particularly in remote or resource-constrained environments.

Monitoring usage of such appliances in remote areas presents additional challenges. Connectivity may be intermittent or unavailable, limiting real-time data transmission. Environmental conditions and infrastructure limitations complicate deployment and maintenance of telemetry systems. As a result, maintaining reliable and complete usage records can be difficult. Conventional monitoring systems, including certain carbon credit verification systems for cookstoves, often rely on limited single-parameter data signals. Such approaches may not provide sufficiently comprehensive or tamper-resistant evidence of appliance usage. Moreover, existing telemetry systems frequently lack adaptive connectivity management capable of preserving data integrity in environments with unreliable communications and power constraints.

Accordingly, there remains a need for integrated household appliances capable of supporting multiple energy-related functions while enabling reliable, verifiable monitoring in areas with limited infrastructure and intermittent connectivity.

### SUMMARY

Described herein are portable household appliances that integrate multiple energy-dependent household functions within a single, transportable housing. In various embodiments, the appliance includes an induction cooktop, a cooler configured for refrigerating or freezing contents, a charging unit for powering external electronic devices, and a rechargeable battery configured to power the integrated subsystems. The battery may be rechargeable via solar input, AC input, or other external power sources. The unified architecture reduces the need for multiple separate appliances and enables coordinated power management, thermal management, and user interface control within a compact system suitable for off-grid or intermittently powered environments.

The appliance may further include an onboard telemetry system comprising at least one processor, memory buffer, and a multi-mode communication module configured to transmit usage data to a remote platform. The telemetry system may collect operational metrics from multiple subsystems to generate a multi-dimensional usage signature, store telemetry records in a buffer, and selectively transmit records using a plurality of communication protocols, such as NB-IoT and LoRaWAN. In some embodiments, the system employs automated communication-mode selection, store-and-forward buffering, sequence-based gap detection, and retransmission logic to maintain data completeness in environments with intermittent connectivity. The transmitted data may be used for remote monitoring, diagnostics, performance analysis, and verification applications.

In one aspect, a portable household appliance includes a housing containing an induction cooktop, a cooler, a charging unit comprising at least one outlet configured for powering other household devices, and a battery configured for powering the induction cooktop, the cooler, and the charging unit, wherein the portable household appliance is configured to be carried by one or two people.

In another aspect, a kit includes the portable household appliance and at least one pot configured for use with the induction cooktop and sized to fit on the induction cooktop.

In another aspect, the portable household appliance includes at least one memory, at least one processor configured to collect usage data from the portable household appliance and store the usage data in the at least one memory, and a multi-mode communication module configured to transmit the usage data to an external data receiver using a plurality of communication protocols.

### BRIEF DESCRIPTION OF THE DRAWINGS

FIG. 1A is a perspective view of an exemplary portable household appliance when the cooler lid is closed, according to some embodiments.

FIG. 1B is a perspective view of the portable household appliance when the cooler lid is open, according to some embodiments.

FIG. 1C is a partially transparent view of the portable household appliance illustrating internal components including the battery and compressor of the appliance, according to some embodiments.

FIG. 1D is a detailed view of an exemplary induction cooktop of the portable household appliance that includes a digital interface, according to some embodiments.

FIG. 1E is a detailed view of a charging unit of the portable household appliance, according to some embodiments.

FIG. 2 is a diagram showing housing dimensions for a portable household appliance, according to some embodiments.

FIG. 3 show a kit including the portable household appliance and a pot, according to some embodiments.

FIG. 4A shows a kit including a portable household appliance, a solar panel, and a cable, according to some embodiments.

FIG. 4B shows a kit including a portable household appliance, a pot, and a portable charger/solar light unit, according to some embodiments.

FIG. 5A shows a portable household appliance having an integrated induction cooktop, according to some embodiments.

FIG. 5B shows a portable household appliance having a removable induction cooktop with a battery integrated into the induction module, according to some embodiments.

FIG. 5C shows a portable household appliance having a removable induction cooktop with a cable connecting the induction module to the appliance, according to some embodiments.

FIG. 6A shows a portable household appliance with a door-type cooler, the door closed, according to some embodiments

FIG. 6B shows the portable household appliance with the door of the cooler closed, according to some embodiments.

FIG. 7A shows a portable household appliance having a recessed lid configuration, the lid open, according to some embodiments

FIG. 7B shows the portable household appliance with the recessed lid closed, according to some embodiments.

FIG. 8 shows a portable household appliance with a side-mounted digital interface, according to some embodiments.

FIG. 9 shows another exemplary portable household appliance with a door-type cooler, according to some embodiments.

FIG. 10 shows another exemplary portable household appliance with a door-type cooler, according to some embodiments.

FIG. 11A shows a portable household appliance having a hinged cooktop, according to some embodiments.

FIG. 11B shows a portable household appliance having a slide cooktop, according to some embodiments.

FIG. 11C shows a portable household appliance having a door fridge, according to some embodiments.

FIG. 11D shows a portable household appliance having a food prep fridge lid, according to some embodiments.

FIG. 11E shows a portable household appliance having an extendable worktop, according to some embodiments.

FIG. 12 is a block diagram of a portable household appliance with processor and memory for data collection, according to some embodiments.

FIG. 13A is a diagram of drive-by data collection from a portable household appliance, according to some embodiments.

FIG. 13B is a diagram of static data collection from a portable household appliance, according to some embodiments.

FIG. 14 is a system architecture diagram of a data communication system for a portable household appliance including telemetry, multi-mode communication, and a cloud MRV platform, according to some embodiments.

FIG. 15A is a flowchart of a device-side data collection and transmission process, according to some embodiments.

FIG. 15B is a flowchart of cloud-side data processing and gap detection, according to some embodiments.

FIG. 15C is a flowchart of device response to a retransmission request, according to some embodiments.

FIG. 16 shows a digital interface including a cooktop section, a cooler section, an energy indicator section, and safety indicators, according to some embodiments.

FIG. 17A is a front perspective view of a portable household appliance having thermal management vents for cool air intake and hot air outflow for the cooktop and cooler, according to some embodiments.

FIG. 17B is a back perspective view of a portable household appliance having thermal management vents for cool air intake and hot air outflow for the cooktop and cooler, according to some embodiments.

FIG. 18A shows a portable solar-powered induction cooker in an attached configuration, according to some embodiments.

FIG. 18B shows the portable solar-powered induction cooker in a detached configuration, according to some embodiments.

FIG. 18C shows a portable solar-powered induction cooker in an integrated configuration, according to some embodiments.

FIG. 19 is a block diagram of a computer system that may be used to implement aspects of the telemetry processor, according to some embodiments.

### DETAILED DESCRIPTION

The present disclosure relates to portable household appliances that integrate multiple energy-dependent household functions within a unified, transportable housing. In various embodiments, the appliance includes an induction cooktop for cooking, a cooler configured for refrigerating or freezing food and medicine, and a charging unit for powering external electronic devices. These subsystems are powered by an internal rechargeable battery that may be charged via solar input, AC input, or other external power sources. The integrated configuration enables coordinated power distribution and control within a compact appliance that may be carried by one or two people.

The single-housing architecture reduces the need for separate appliances and independent power connections, thereby decreasing system complexity, wiring, and maintenance requirements. In some embodiments, the housing employs a deep-draw construction method that enhances structural rigidity and durability. A deep-draw aluminum liner for the cooler may further improve cleanability and longevity. These construction techniques can improve robustness in demanding operating environments while maintaining a compact form factor.

The appliance may further include a telemetry system configured to collect operational metrics from multiple subsystems, including cooking activity, cooling cycles, battery charge and discharge patterns, and solar energy input. By aggregating metrics from these distinct subsystems, the system can generate a multi-dimensional usage signature that reflects overall appliance operation. Compared to single-parameter monitoring approaches, this multi-subsystem data set may provide more comprehensive usage verification and enhanced resistance to manipulation.

In some embodiments, the telemetry system employs a tiered communication architecture that supports multiple transmission protocols, such as NB-IoT and LoRaWAN. Automated communication-mode selection, store-and-forward buffering, drive-by or static gateway collection, and retransmission logic may be used to maintain data completeness in environments with intermittent connectivity. Adaptive data collection granularity—such as varying sampling rates based on appliance state—may further balance evidentiary richness, power consumption, and payload size constraints.

The disclosed appliances may be implemented in off-grid, remote, consumer, camping, or emergency-relief contexts. Design considerations may include durability, repairability, extended battery cycle life, distributed operability, telemetry-based observability, and integrated safety protections. Collectively, these features provide a compact, multi-function appliance architecture that integrates energy generation, storage, utilization, and monitoring within a single portable system.

### Portable Household Appliances

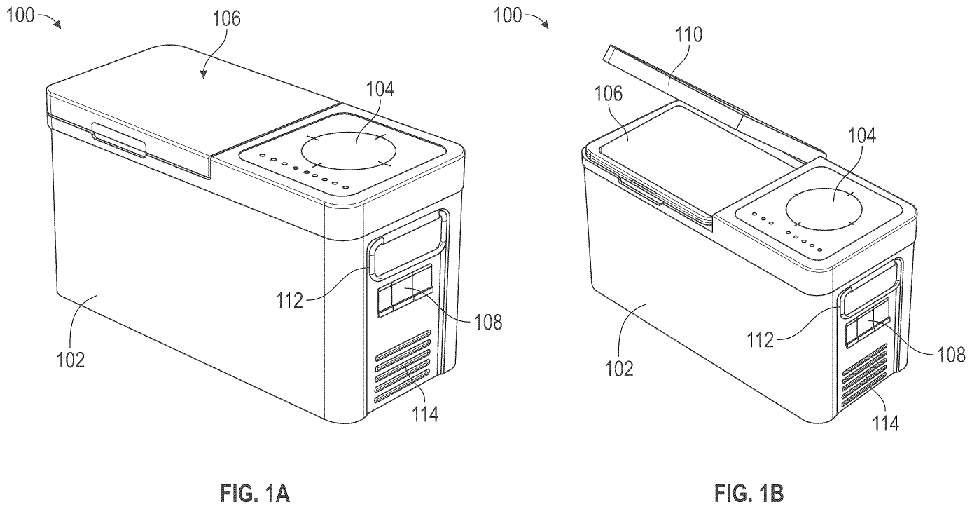

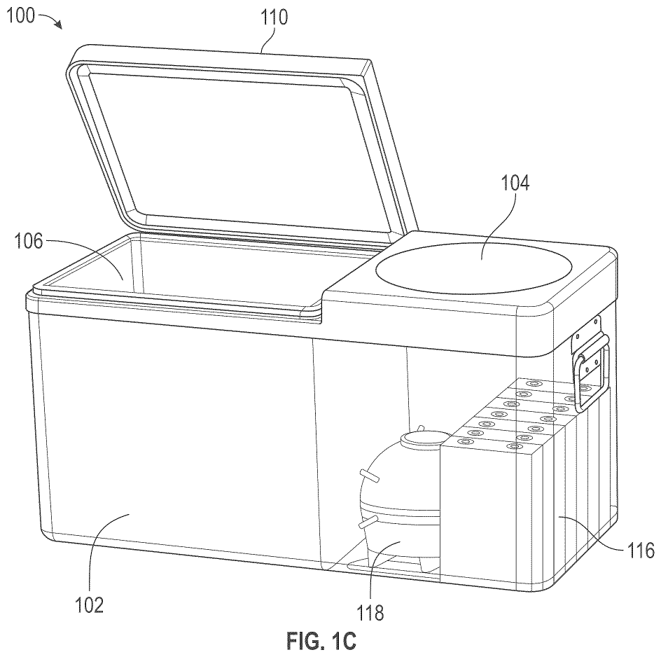

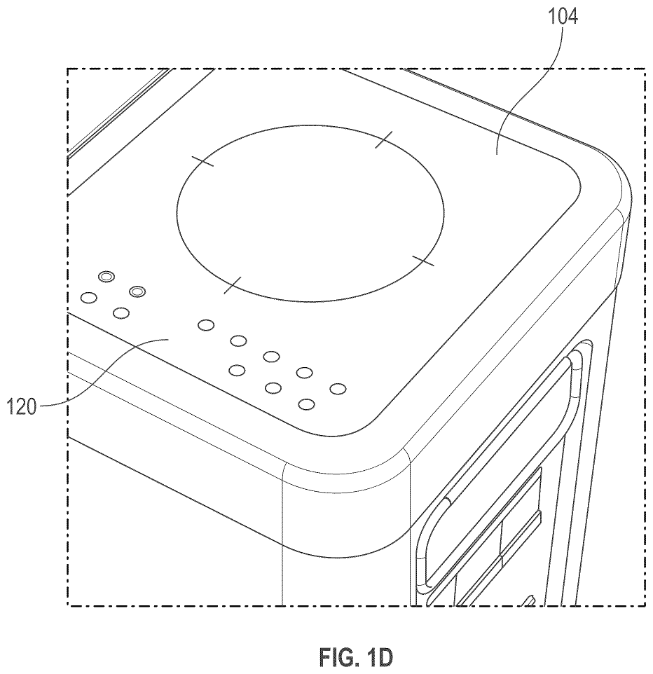

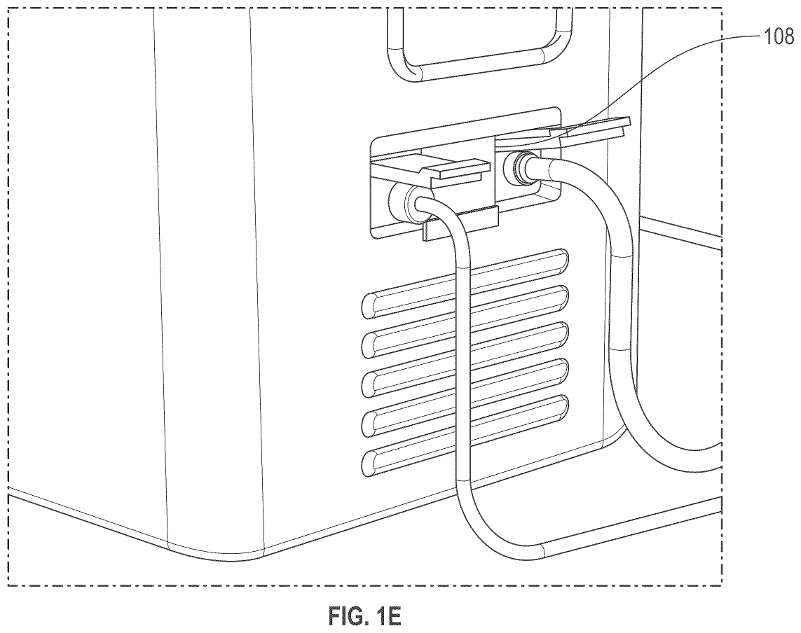

FIGS. 1A-1E illustrate various views of a portable household appliance 100. The portable household appliance 100 functions as a cohesive whole within a single housing 102 while allowing individual components to operate independently when needed. The single housing design can be beneficial in reducing the number of cables and plugs in the household to the bare minimum, thus ensuring safety in tight spaces.

As shown in FIGS. 1A-1B, the housing 102 can include one or more handles 112 for carrying the portable household appliance 100. For example, the one or more handles 112 can be positioned on the side of the housing 102. The handles 112 can enable one person to carry the housing 102 on his/her own. Alternatively, two people can carry the housing 102 together (e.g., one on either side).

The portable household appliance 100 can weigh less than 25 Kg, in some examples less than 21 Kg when empty (e.g., no food), to enable carrying by just one person or by two people if necessary (e.g., dependent on the size of the person). In some embodiments, the portable household appliance 100 weighs approximately 21 kg when empty and approximately 30 kg when loaded with food. The target weight for the portable household appliance with cooler may be less than 30 kg when the cooler is empty.

The housing 102 can be composed of stainless steel, aluminum, plastic, polymer, steel, glass, and/or ceramic glass. These materials can comprise both the internal and/or external structures of the housing 102. For example, bamboo could be used for the top surface of the lid 110 for the cooler 106, thus serving as a chopping block for preparing food. In some examples, the induction cooktop 104 can include ceramic glass. Ceramic glass exhibits high strength, scratch resistance, and excellent resistance to thermal shock and high temperatures.

In some embodiments, the housing 102 employs a deep-draw construction method for the outer casing, which provides superior durability compared to other products in this space. The deep-draw construction method is particularly advantageous for creating a robust, long-lasting unit. Additionally, a deep-draw central aluminum container may be used for the cooler 106, providing improved cleanability compared to conventional construction techniques. This construction approach supports the goal of having the unit as cleanable as possible.

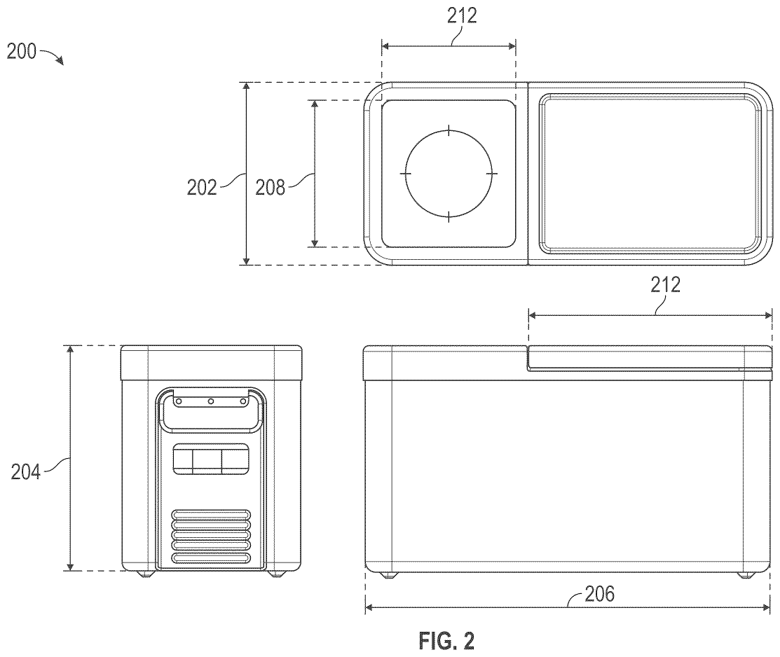

The housing 102 can be rectangular in shape. FIG. 2 illustrates dimension diagrams 200 for the portable household appliance showing the housing 102 with housing width 202, housing height 204, housing length 206, cooktop width 208, and cooler length 212. The dimension diagrams 200 illustrate the relative proportions of the various components within the single housing 102. For example, with reference to FIG. 2, a height 204 of the housing 102 can be between about 300-1000 mm, such as about 400-600 mm, about 400-500 mm or about 400-450 mm. A length 206 of the housing 102 can be between about 500 -1500 mm, such as about 500-900 mm, about 500-800 mm, about 600-800 mm, or about 600-700 mm. A width 202 of the housing 102 can be between about 250-800 mm, such as about 300-500 mm, about 300-400 mm, or about 300-350 mm.

In one exemplary embodiment, the portable household appliance 100 has dimensions of approximately 845 mm (length)×405 mm (width)×455 mm (height). These dimensions provide a compact form factor while accommodating all integrated subsystems. In another exemplary embodiment, the appliance may have dimensions of approximately 840 mm (length)×405 mm (depth)×465 mm (height).

In some examples, the housing 102 includes legs for raising the housing 102 off the ground. In some examples, the legs can be retractable within the housing 102. In some examples, the housing 102 includes at least one set of wheels for transporting the portable household appliance 100.

### Cooktop

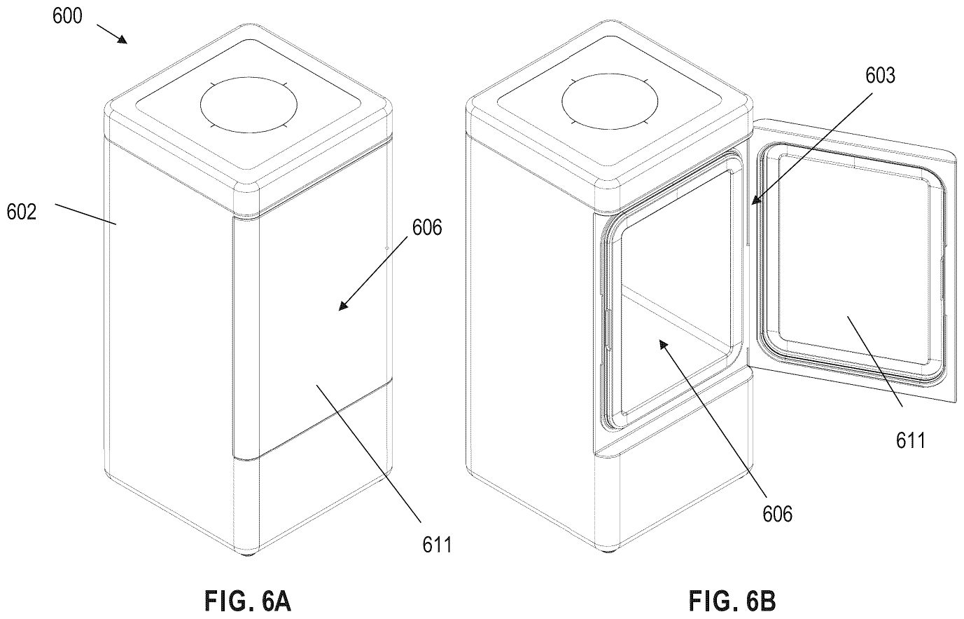

The cooktop may be an induction cooktop 104, illustrated in detail in FIG. 1D. The induction cooktop 104 can be on a top portion of the housing 102. The induction cooktop 104 can be adjacent to a lid 110 of the cooler 106, as shown in FIGS. 1A-1C. In another example, the induction cooktop 104 can be above the cooler 106 (e.g., for a door-type fridge), as shown in FIGS. 6A-6B. An induction cooktop can be beneficial because the cooktop itself does not get hot. An induction cooktop is also easy to clean. Induction cooktops most commonly use AC power; thus, an AC-powered induction cooktop may be contained within the housing 102. Alternatively, a DC-powered induction cooktop may be contained within the housing 102. A DC-powered cooktop may be advantageous in avoiding the high-power inverter necessary for an AC-powered cooktop. Both types of cooktops can have great energy efficiency compared to alternative technologies, but DC induction can gain about 6% energy savings over AC.

The induction cooktop 104 may have a power level between about 800-2000 W. Alternatively, the induction cooktop 104 may have a maximum power of 800 W. The induction cooktop 104 can have adjustable power levels, e.g., power levels 1-9. The expected length of time to cook at maximum heat using battery power only may be approximately 3-4 hours.

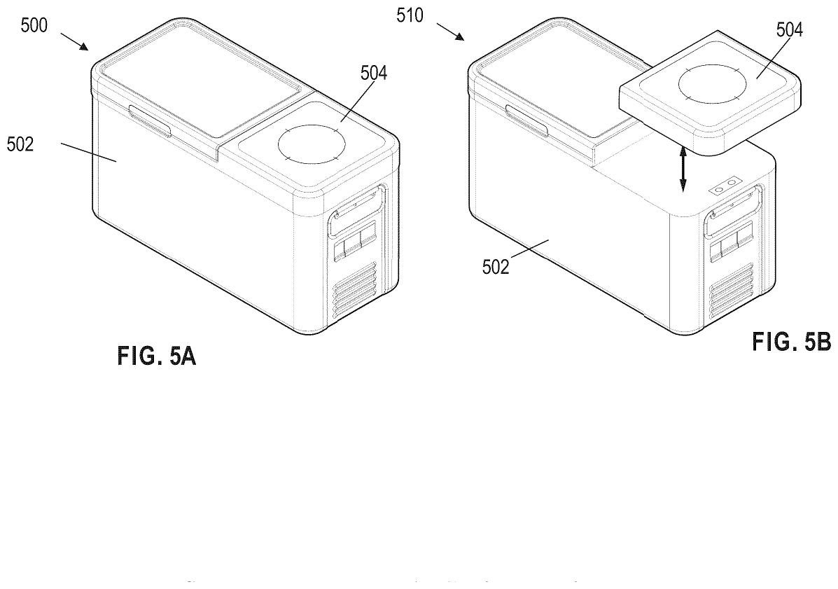

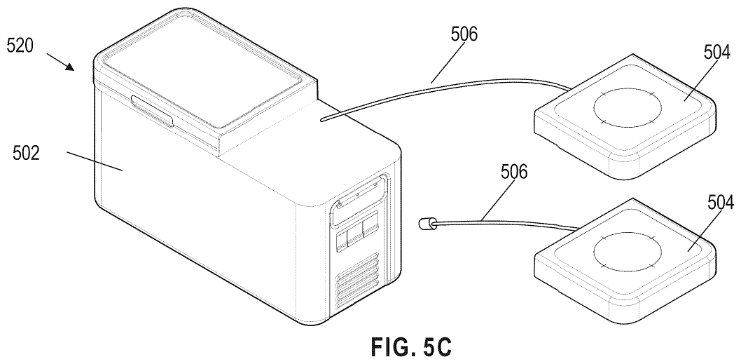

As shown in FIGS. 5A-5C, the induction cooktop 504 can be integrated with the housing 502 (FIG. 5A) or detachable from the housing 502 (FIGS. 5B-5C). For example, the induction cooktop module can be unlocked from the housing 502 and can be connected back to the battery of the portable household appliance with a cable 506 (FIG. 5C). The cable 506 can connect to the charging unit or can connect directly to the battery. In another example, the detachable induction cooktop may have its own battery (FIG. 5B).

The portable household appliance may be configured such that the induction cooktop is removable, with multiple connection options. In one configuration, the removable induction cooktop is joined to the housing by a cable for power connection. In another configuration, the removable induction cooktop may include its own battery for portable cooking, then be returned to the base station to connect to the larger battery for recharging. These same options can apply to both fridge and non-fridge versions of the portable household appliance.

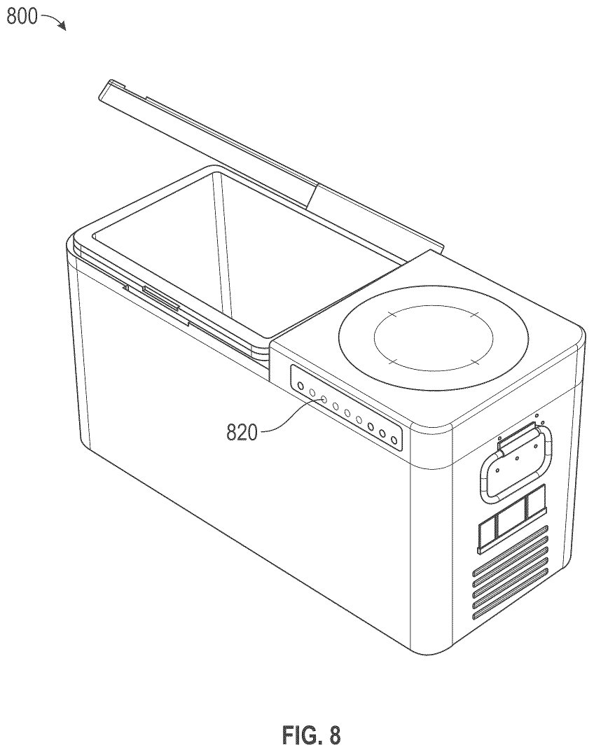

The induction cooktop 104 can include a digital interface 120, as shown in FIG. 1D. In some examples, the digital interface 120 is on a side of the housing 102, as shown at least in FIG. 8. In some examples, the induction cooktop 104 can include a non-digital interface, such as one or more buttons, knobs, switches, etc. for operating the induction cooktop 104.

The cooktop may have a length and/or width between about 200-1000 mm, such as between about 200-400 mm, about 200-300 mm, or between about 250-300 mm.

In some examples, the cooktop includes one burner. In some examples, the cooktop includes more than one burner, such as two, three, four or more burners. The burners may be adjacent to one another on the housing, or may be separate.

### Cooler

The cooler 106 can be a chest-type fridge having a lid 110 that is part of the housing 102. In particular, the lid 110 can be part of a top portion of the housing 102, as shown in FIGS. 1A-1B. A chest-type fridge can improve efficiency, as cold air is less likely to escape when the lid 110 is open because it wants to stay low due to its heavier weight. The cooler 106 can be large enough to store about a week's worth of food. For example, the cooler can be about 550×300×300 mm. The size of the cooler can vary depending on the size of the portable household appliance. In some examples, the height of the cooler can be tall enough for commonly sized cartons and bottles to stand upright. The liner of the cooler can be composed of a tough, hard wearing, easy to clean material, such as plastic, polymer, and/or metal.

In some examples, the cooler 106 has a capacity of approximately 30 liters with inner cavity dimensions of approximately 353×264×374 mm. The cooler 106 may have a temperature range of −20 °C to +20 °C, enabling operation as either a refrigerator or a freezer. The maximum power consumption of the cooler is approximately 60 W. The temperature range may also be +5 °C to −20 °C depending on the desired operating mode.

The expected length of time to run the cooler 106 using battery power only may be approximately 3-5 days. This extended operational time enables the portable household appliance to function effectively in off-grid environments for extended periods.

In some examples, the cooler 106 can be a door-type fridge having a front door 611 that is part of the housing 602. An example of a door-type fridge is shown in FIGS. 6A-6B. The housing 602 may include a hinge 603 that the door 611 connects to and hinges from to open and close the door 611. Alternatively, the door can be a sliding door that laterally slides relative to the housing 602.

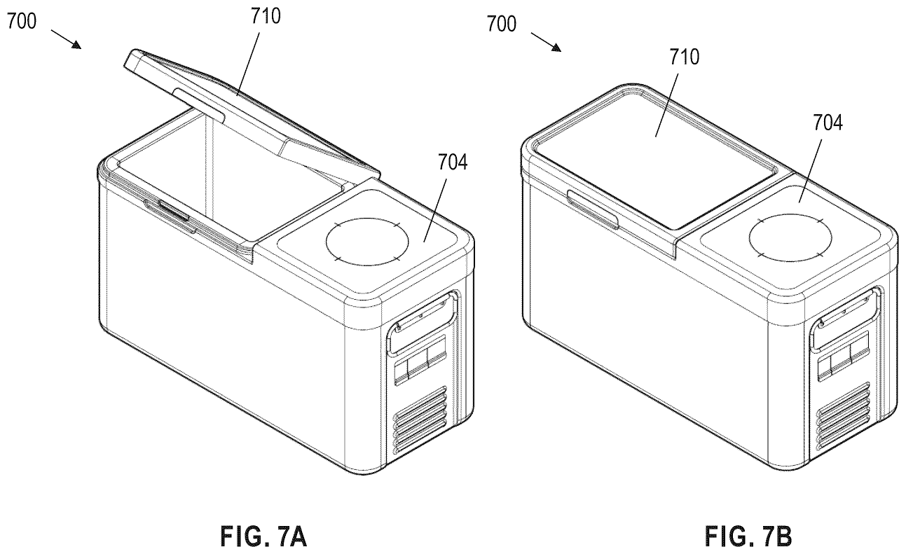

The lid 110 of the cooler 106 may have a length between about 300-1800 mm, such as about 300-600 mm, about 300-500 mm, or about 400-500 mm. The top surface of the lid 110 may be flush with the induction cooktop 104, or may be recessed 710, as shown in FIGS. 7A-7B.

The cooler 106 can include a compressor 118, shown in FIG. 1C. The compressor 118 can be a DC or AC compressor that is powered directly from the battery 116, improving energy efficiency. The compressor 118 can have a variable speed, enabling a wider range of temperature options. For example, the variable speed of the compressor 118 can enable the cooler 106 to run at fridge or freezer temperatures.

The cooler 106 may have multiple operating modes, such as an economy mode (“Eco”) and a full power mode (“full blast”). The selection of operating mode may be controlled via the digital interface or user interface. The operating mode selection allows users to balance energy consumption against cooling performance based on their needs and available power.

The cooler 106 can include a refrigerant. The refrigerant can be selected such that it is sustainable. Exemplary refrigerants that may be used can include R290 and R600a.

### Charging Unit

The charging unit 108 can be configured for charging a large range of devices, including both known devices and currently unknown devices. For example, the charging unit 108 can be configured for charging electrically powered household tools, laptops, televisions, radios, lights, cell phones, electrically powered fans, and other charging/light devices (e.g., “StudentBuddy,” as described in U.S. Pat. No. 11,988,360).

The charging unit 108 can be configured to receive an inverter (e.g., a 12-V inverter) for charging AC devices. This can allow the user to power older devices (e.g., older laptops). The charging unit 108 can include a USB-A outlet for charging other devices. The charging unit 108 can include a USB-C outlet for charging newer devices (e.g., newer laptops). The outlets of the charging unit 108 described herein are not intended to be limited to outlets for receiving an AC inverter, USB-A, and/or USB-C connection. It is understood that the charging unit 108 of the portable household appliance 100 described herein may be couplable to other similarly functioning cables/connectors.

In one exemplary embodiment, the charging unit 108 includes multiple USB-A outlets, USB-C PD (Power Delivery) outlets capable of up to 100 W, and 12V outlets. The USB-C PD capability can enable rapid charging of compatible devices such as modern laptops and smartphones.

The charging unit 108 may be located on a side of the housing 102, as shown in FIGS. 1A-1B and in FIG. 1E in detail. In some examples, the charging unit 108 is located on the top surface of the housing 102. The charging unit 108 may include covers for covering the plugs when not in use.

### Powering a Portable Household Appliance

The portable household appliances described herein can include a battery 116, as shown in FIG. 1C. The battery 116 can be charged by either solar power or AC power. If connected to a solar panel 306, the battery 116 can continuously charge (assuming there is enough sunlight). If plugged into an AC power source, the battery 116 will also recharge. If the portable household appliance 100 is not connected to an AC power source or solar power source, the portable household appliance 100 may last for at least one hour of cooking, or 100 hours of refrigeration, although the lifespan of the battery before needing to be charged is dependent on the size of the battery and use case. A small battery may only last one hour while cooking, whereas a larger battery could last for 3 hours of cooking or 250 hours of refrigeration. Lithium battery self-discharge rate is low at about 5% per month, allowing for intermittent use and reduced user maintenance.

In one exemplary embodiment, the battery 116 is a lithium-ion battery with specifications of 25.6V and 100 Ah, providing a capacity of 2.56 kWh. The battery 116 may employ Lithium Iron Phosphate (LiFePO4 or LFP) cell chemistry. The battery 116 may have a maximum charging and discharging current of 100 A. The battery pack may have dimensions of approximately 320×270×165 mm and weigh approximately 21±0.8 kg.

The power requirements of the induction cooktop 104 dictate the battery size selection. Smaller and larger batteries could be used, but the current battery type, size, and capacity were chosen based on current technology and performance requirements. In the future, improvements in battery or capacitor technology may better suit the purpose of the portable household appliance.

The battery 116 is expected to provide 5000+ charge cycles. This longevity ensures that the portable household appliance 100 can provide years of reliable service. The battery 116 may include a Battery Management System (BMS) for monitoring and protecting the battery cells.

The expected time to charge the battery 116 from 0% to 100% may be approximately 5-6 hours depending on sunlight availability. The time to recover charge from typical daily use may be approximately 3-4 hours. Typical daily use may consume approximately 60% of battery capacity, with extra battery capacity reserved for atypical days and bad weather conditions.

In the portable household appliance with cooler version, the battery 116 can be positioned in different locations within the housing 102. For example, the battery 116 could be flat under the cooler 106, or in a carved-out recess within the cooler cavity, or in a slightly different orientation within the unit. This flexibility in battery placement enables optimization of the overall appliance design.

The choice of the plug for the solar and AC power can be critical to the longevity of the portable household appliance 100. The solar plug may be water resistant, durable for daily use, and able to be disconnected while power is flowing. The solar plug can have a quick release locking mechanism. The solar plug can have an IP67 waterproof rating. The solar plug can have robust strain relief. The solar plug can have a high mating cycle count. The solar plug may mount flush with the panel of the portable household appliance 100. An exemplary solar plug that may be used is BD-24. The AC plug may be ubiquitous in most countries. The AC plug may be protected by a splash guard. An exemplary AC plug that may be used is IEC-60320.

The battery 116 of the portable household appliance 100 may be stored within the housing 102, adjacent to the cooler 106. The battery 116 may be charged by 1, 2 or more solar panels (e.g., new and/or second-life solar panels), although the number and size of panels may vary. The battery 116 may have a capacity between 1.8-2.6 KWh and wattage of between 1.3-2.6 KW, such as a wattage between about 1.8-2.2 KW.

The battery 116 may include prismatic cells. For example, the battery 116 may include about 8 prismatic cells in a cell holder. The prismatic cells may be of a major manufacturer to ensure longevity of the portable household appliance. Prismatic cells also vastly reduce the number of connections, are repairable, and are an efficient use of space.

The portable household appliances may include several safety measures, such as using lithium iron phosphate (LFP) cell chemistry, active cell balancing, heat alarms, over voltage protection (OVP), and over current protection (OCP), secondary OVP and OCP.

### Portable Household Appliance Kits

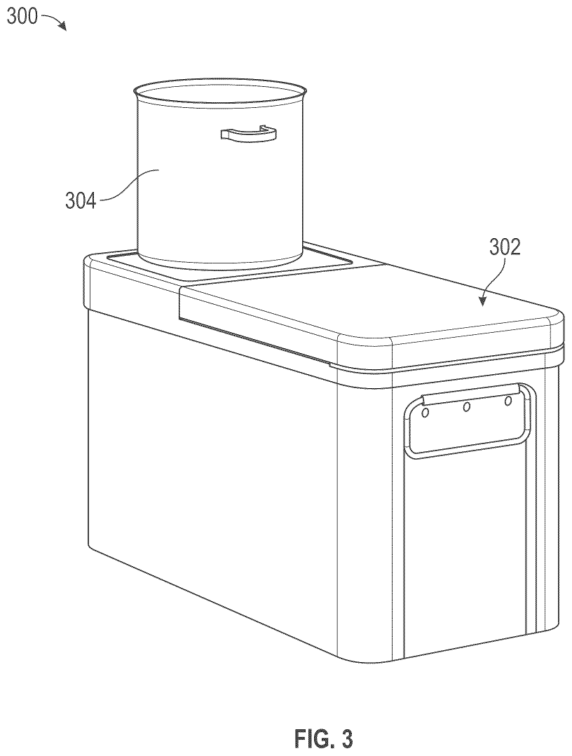

The portable household appliances described herein may be provided as part of a kit 300. As shown in FIG. 3, the kit 300 can include the portable household appliance 302 and at least one pot 304 and/or pan configured for use with the induction cooktop. This is because induction cooktops do not work with all cookware. So, the portable household appliances described herein can be provided as part of kit 300 that includes compatible cookware, such as a pot 304. The pot 304 may be sized to fit on the induction cooktop. As described herein, the portable household appliance 302 may be provided with the pot 304 stored in the cooler 106 for easy transporting. Thus, the pot 304 may be sized such that it functions with the induction cooktop and also fits within the cooler 106.

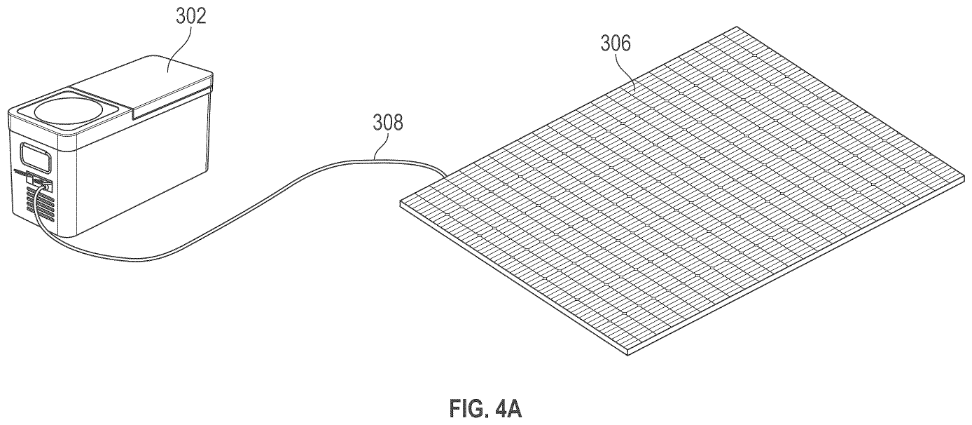

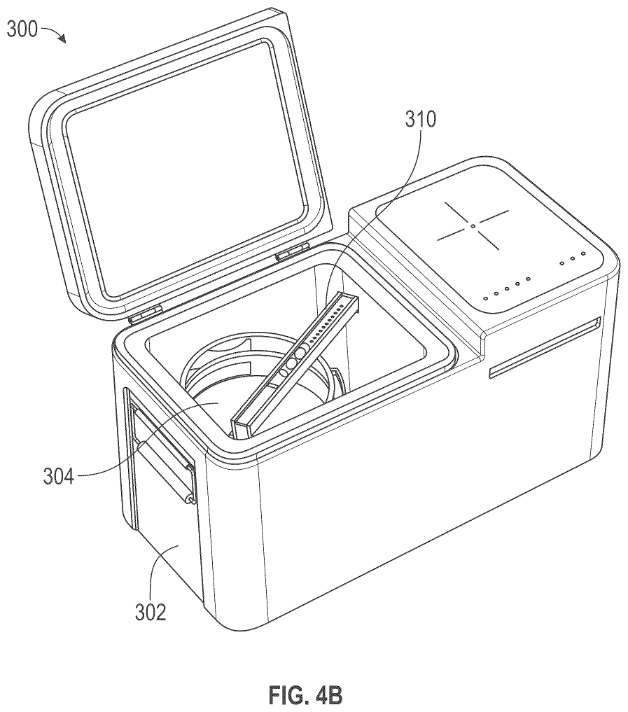

The kit 300 can also include at least one solar panel 306 for powering the portable household appliance 302, as shown in FIGS. 4A-4B. In some examples, the kit 300 can include a cable 308 for connecting the solar panel 306 to the portable household appliance 302, as shown in FIG. 4A. In some examples, the kit 300 can include an AC inverter, such as a 200 W AC inverter as described herein. In some examples, the kit 300 can include a cable for charging the charger/solar light unit described herein and otherwise referred to as “StudentBuddy.” The kit 300 may also include a portable charger/solar light unit 310.

### Alternative Portable Household Appliance Embodiments

FIGS. 9 and 10 illustrate alternative embodiments of portable household appliances 900, 1000 that include a housing containing an induction cooktop, cooler 906, and charging unit.

For example, FIG. 9 can include a cooler 906 having a door 911, rather than a lid 110 as shown in and described at least with respect to FIGS. 1A-1E.

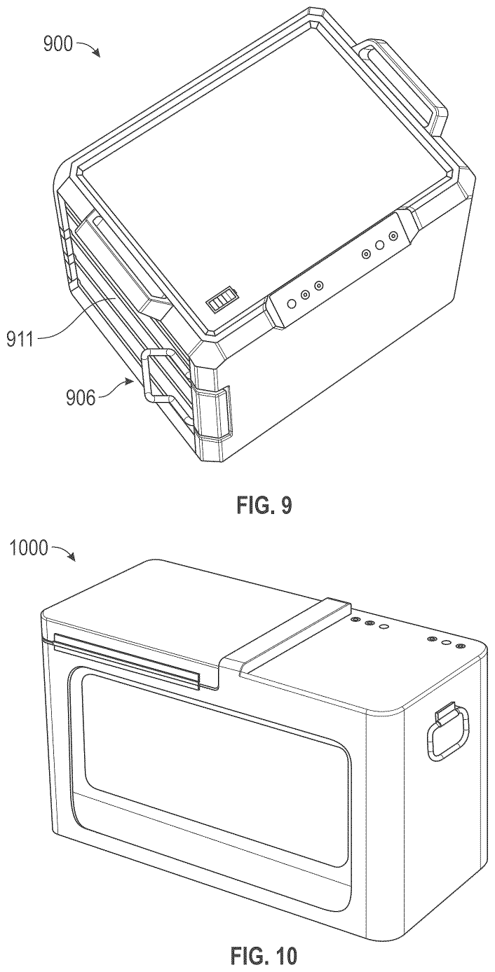

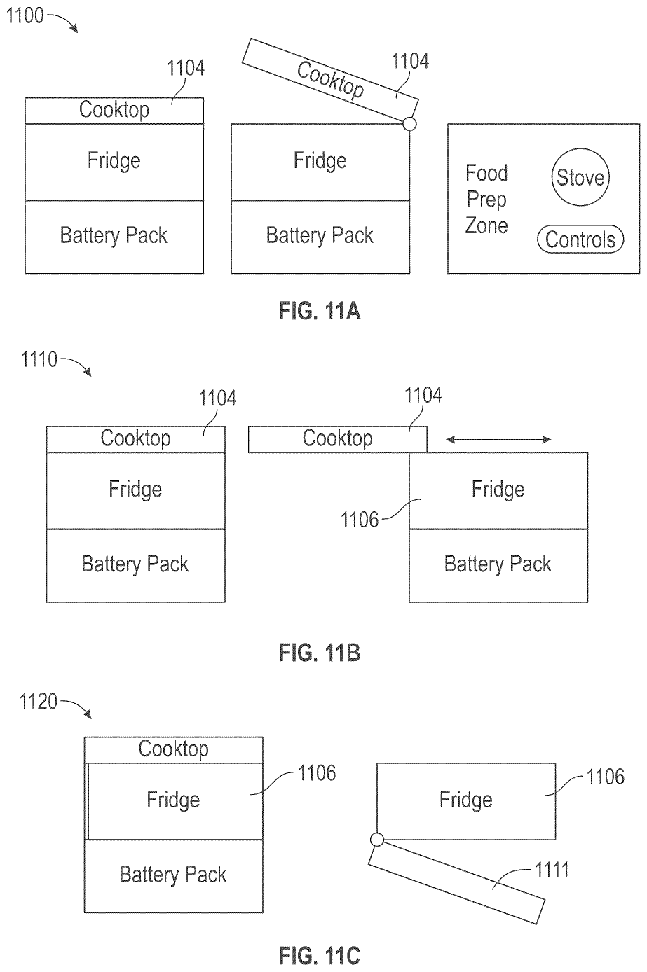

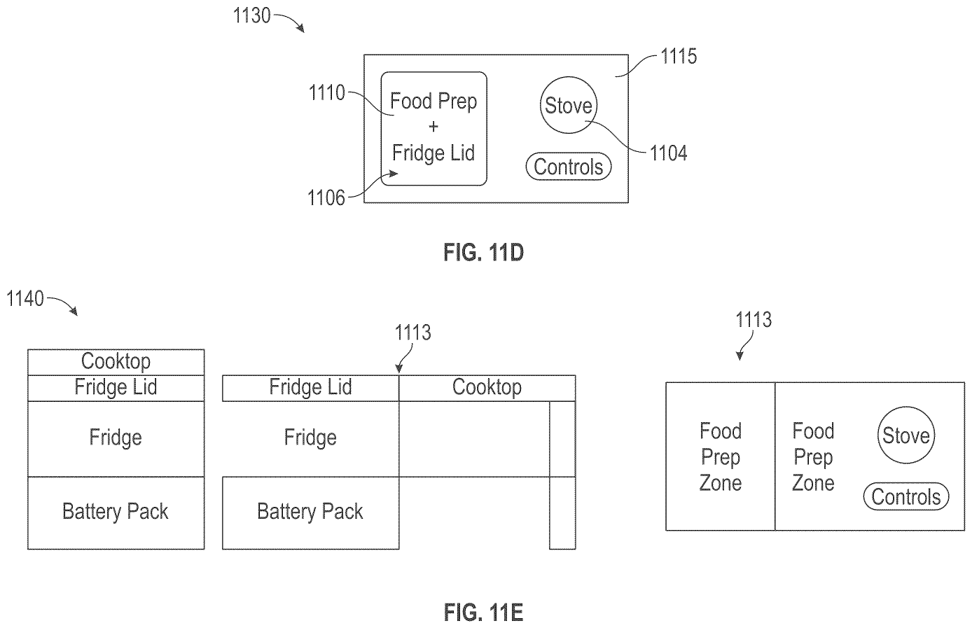

FIGS. 11A-11E illustrate additional alternative embodiments 1100, 1110, 1120, 1130, 1140 of portable household appliances. As shown in FIG. 11A, the cooktop 1104 may be hinged such that cooktop 1104 acts as the lid to the cooler 1106. In FIG. 11B, the cooktop 1104 may slide to access the cooler 1106. In FIG. 11C, similar to FIG. 9, the cooler 1106 can have a door 1111. In FIG. 11D, the cooler 1106 and cooktop 1104 split the top surface 1115 of the housing and the cooler 1106 has a lid 1110. In FIG. 11E, the worktop 1113 of the portable household appliance 1140 is extendable.

### User Interface/Digital Interface

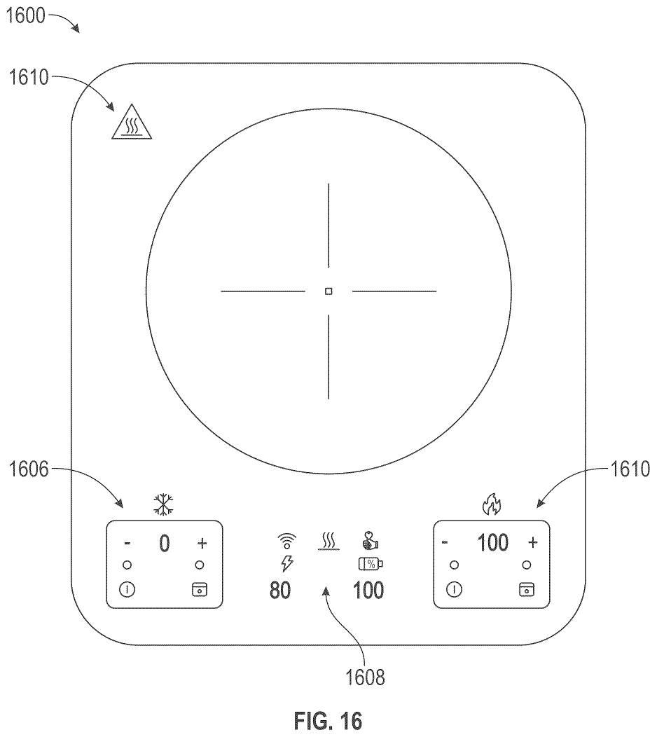

As shown in FIGS. 8 and 16, the portable household appliance may include a digital interface 820, 1600 for user control and status display. The digital interface 1600 may be designed for intuitive use across varying literacy levels, languages, and cultural settings.

As illustrated in FIG. 16, the digital interface 1600 may include a cooktop section 1604 for controlling the induction cooktop, a cooler section 1606 for controlling the cooler, and an energy input/output/storage indicator section 1608 for displaying energy status. The digital interface 1600 may also include safety conditions and warning indicators 1610.

The digital interface 1600 can support multiple critical functions, including: clear and safe operation of the cooktop and cooling system; visibility of energy input, storage, and output status; and/or communication of safety conditions and warnings. The digital interface 1600 may differentiate between user errors and system faults, with guidance that supports corrective action. This differentiation can be advantageous because it helps users understand whether an issue requires their action or indicates a system malfunction requiring service.

### Thermal Management and Ventilation

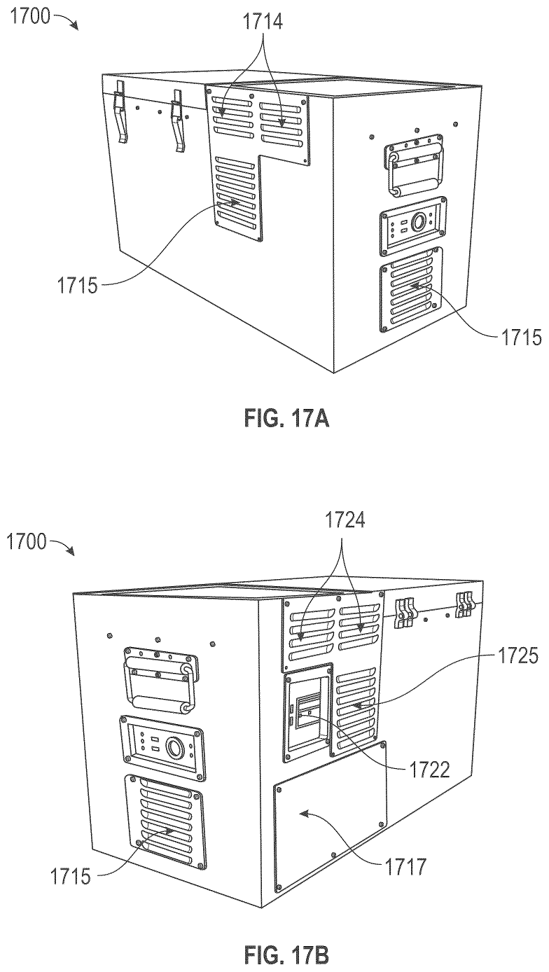

FIGS. 17A-17B illustrate a portable household appliance 1700 demonstrating vents operably coupled to fans for thermal management, which can be employed in any of the portable household appliances described herein. Effective thermal management may be critical for the proper operation of both the induction cooktop and the cooler within a compact integrated housing.

As shown in FIGS. 17A-17B, the portable household appliance 1700 includes at least one vent 1714 for cool air intake for the cooker (induction cooktop), at least one vent 1715 for cool air intake for the fridge (cooler), at least one vent 1724 for hot air outflow from the cooker, and at least one vent 1725 for hot air outflow from the fridge.

The separation of air intake and outflow vents for the cooker and fridge subsystems provides several technical advantages. First, it prevents thermal cross-contamination between the heat-generating induction cooktop and the cooling components of the refrigerator. Second, it enables independent thermal management of each subsystem, optimizing both cooking and cooling efficiency. Third, the dedicated ventilation pathways ensure adequate cooling airflow even when one or both subsystems are operating at high power levels.

The vents 1714, 1715, 1724, 1725 may be operably coupled to fans (not shown) that actively circulate air through the respective subsystems. Fan control data, including fan speed target and current fan speed, may be monitored by the telemetry system. This enables remote diagnostics of thermal management performance.

FIG. 17B further illustrates power control 1722 at a back side of the portable household appliance 1700 for powering the appliance on and off. The back side of the portable household appliance 1700 (and/or another side of the appliance) may include a battery pack door 1717 for accessing the battery.

### Portable Solar-powered Induction Cooker

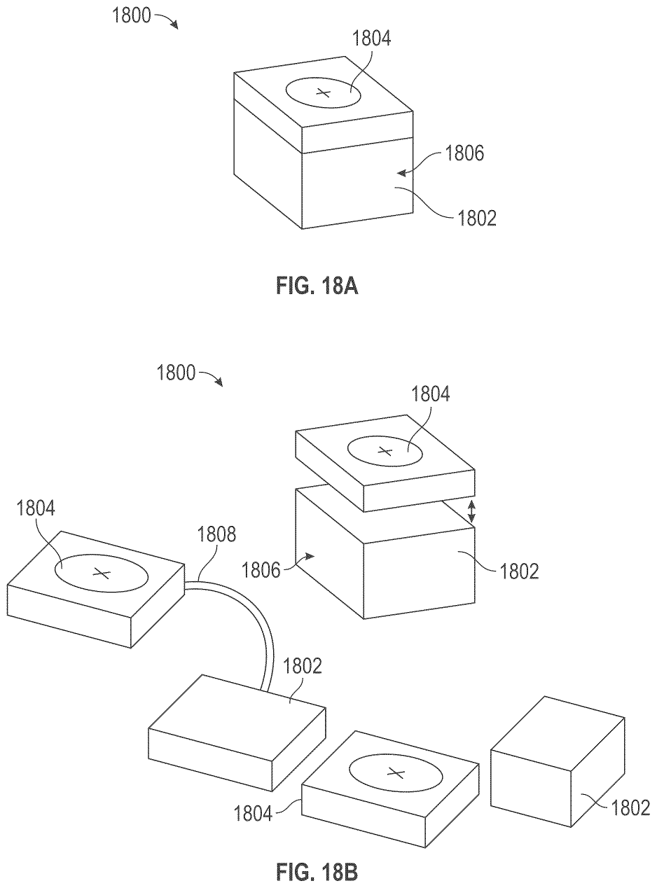

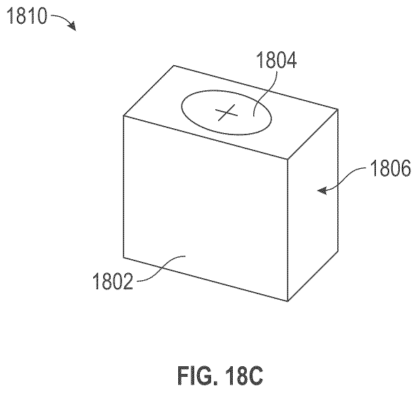

FIGS. 18A-18C illustrate embodiments of a portable solar-powered induction cooker 1800, 1810 that may be provided separately or as an alternative to the full portable household appliance with cooler.

As shown in FIG. 18A, the portable induction cooker 1800 may have an integrated configuration where the induction cooktop 1804 and battery 1816 are permanently housed together within the housing 1802. This configuration can provide a compact, all-in-one portable cooking solution that can be charged via solar power.

As shown in FIG. 18B, the portable induction cooker 1800 may have a detached configuration where the induction cooktop 1804 is separable from the housing 1802. In this configuration, the induction cooktop 1804 may be connected to the housing 1802 via a cable 1808 (corded connection) or may operate wirelessly (cordless connection).

As shown in FIG. 18C, an integrated portable induction cooker 1810 may combine the cooking surface with the power source in a unified design. This configuration may be particularly advantageous for users who do not require cooling functionality but need a portable, solar-powered cooking solution.

The principle of the portable solar-powered induction cooker applies to both fridge and non-fridge versions of the portable household appliance. In the fridge version, the same options for integrated, corded detachable, and cordless detachable configurations are available.

### Lighting

The portable household appliance may include integrated lighting. In one exemplary embodiment, the lighting provides multiple brightness levels of approximately 370, 240, and 30 lumens. The multiple brightness levels enable users to select appropriate illumination for different tasks and conditions while conserving battery power when full brightness is not required.

### Data Observability and Telemetry System Architecture

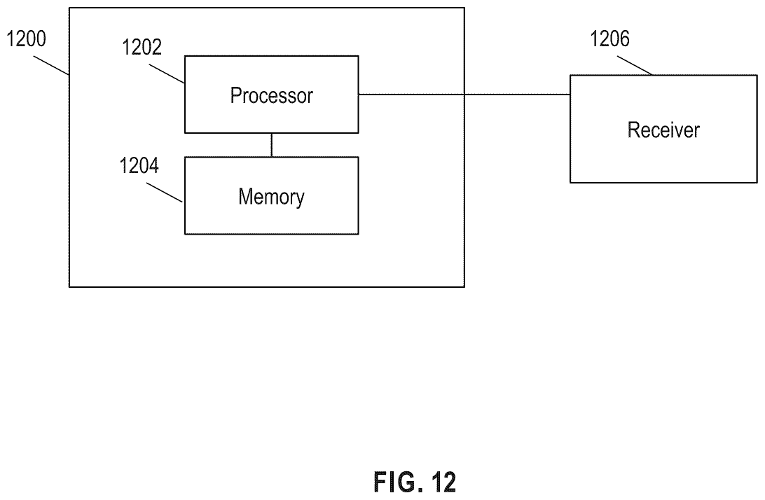

As shown in FIG. 12, the portable household appliance 1200 can include at least one memory 1204 and at least one processor 1202 that is configured to collect usage data from the portable household appliance 1200 and store the usage data in the at least one memory 1204. The at least one processor 1202 can be configured to enable access to the usage data that is stored in the at least one memory 1204 by an external data receiver 1206.

The at least one processor 1202 and the external data receiver 1206 can be configured to communicate over a long-range, low-power communication mode (LoRa). LoRa enables long-range (up to 20 Km), low-power communication, making it ideal for collecting data in remote areas with minimal infrastructure. LoRa has limited bandwidth and data transmission speed, restricting the type and amount of data that can be sent in real-time. This can be mitigated by aggregated and real-time data telemetry. The aggregated usage data can include lifetime usage information such as the total amount of electrical power used, number of USB devices charged, etc. The aggregated usage data can be relatively small so that it can be collected intermittently and quickly. Real-time usage data can require more frequent collection but can also offer much deeper insight into the health and usage of a portable household appliance. A continuous connection is not essential as data can be buffered in the at least one memory 1204 of the portable household appliance 1200 for periods of time.

LoRa can also use LoRaWAN networks which are deployed in many areas. This method is regularly used for asset tracking.

Alternatively, in some examples the at least one processor 1202 is configured to be connected to a mobile phone, e.g., via Bluetooth, WiFi, etc. For example, the portable household appliance may support connectivity to cellular networks, satellites, and Bluetooth in addition to LoRaWAN and NB-IoT. This multi-mode connectivity approach can ensure that data can be collected across a wide range of infrastructure scenarios.

In “Gateway-less” configurations, the portable household appliance may include a Terrestial network or WiFi card for direct connectivity without requiring an external gateway. This option can provide 2G-3G-4G-5G/WiFi connectivity diagnostics including signal strength and network name. SIM remote control and diagnostics may also be available in this configuration.

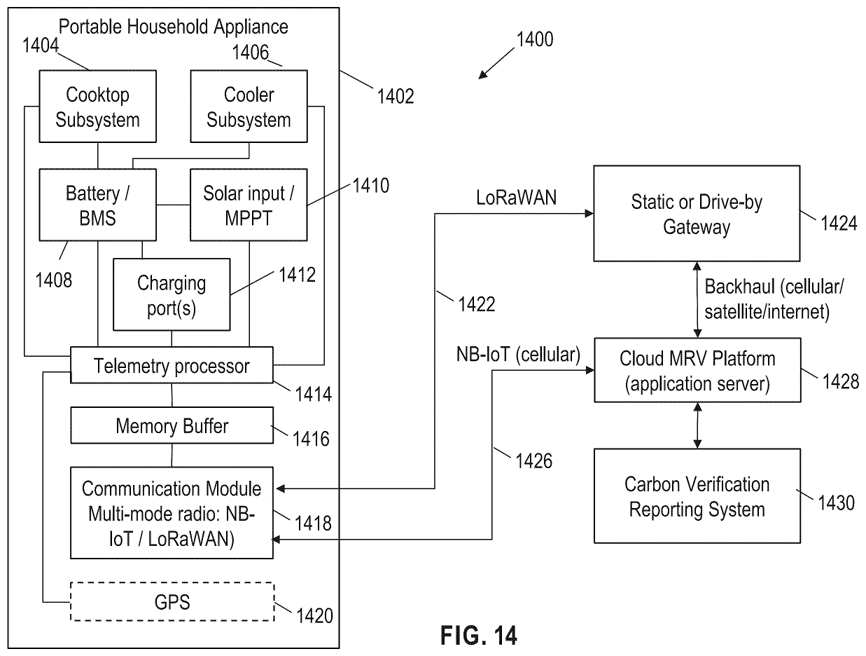

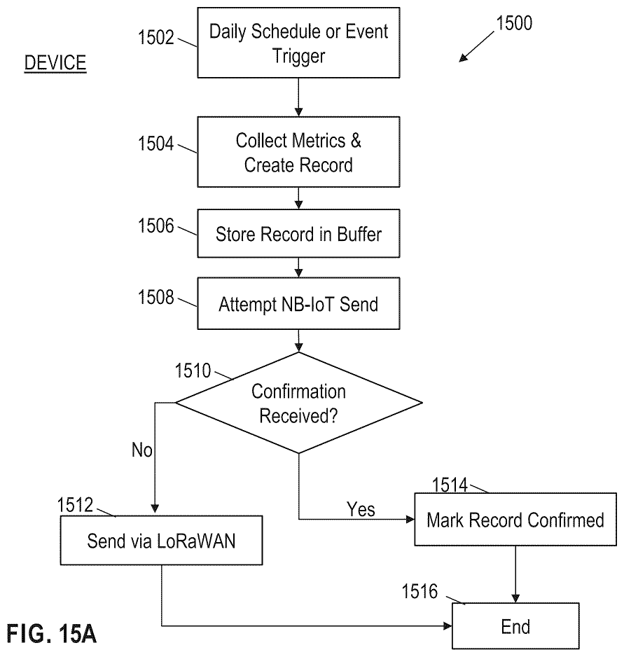

FIG. 14 illustrates a detailed data communication system 1400 for the portable household appliance 1402, showing the telemetry and communication architecture. The portable household appliance 1402 includes a cooktop subsystem 1404, a cooler subsystem 1406, a battery/BMS (Battery Management System) 1408, and solar input/MPPT (Maximum Power Point Tracking) charge controller 1410. The portable household appliance 1402 further includes charging port(s) 1412 for external device charging.

The telemetry system includes a telemetry processor 1414, a memory buffer 1416, and a communication module 1418. The communication module 1418 can be a multi-mode radio capable of communicating via NB-IoT (Narrowband Internet of Things) 1426 and/or LoRaWAN 1422. In some examples, the communication module 1418 may be capable of communicating via 2G, 3G, 4G-LTE, 5G-NR, satellite direct, Bluetooth, WiFi, and/or LoRa as an alternative to NB-IoT. The portable household appliance 1402 may optionally include GPS 1420 for location tracking.

The communication module 1418 communicates with a gateway 1424, which may be either static or drive-by (portable). The gateway 1424 can connect via backhaul (cellular/satellite/internet) to a cloud MRV (Measurement, Reporting, and Verification) platform 1428 and a cloud verification reporting system 1430.

The multi-function nature of the portable household appliance—cooking, refrigeration, lighting, and charging—creates a multi-dimensional usage signature that may be inherently harder to falsify than a single on/off signal. A device showing simultaneous cooktop energy draw, refrigeration compressor cycling, battery charge and discharge patterns, and solar input correlation produces a usage fingerprint that may be both richer evidence for verifiers and significantly more difficult to manipulate than a simple temperature sensor or accelerometer reading. The communication and data system may be specifically structured to capture and transmit this multi-dimensional signature in a way that conventional single-purpose cookstove monitoring systems are architecturally incapable of doing.

The communication module 1418 may employ multi-mode communication logic to ensure reliable data transmission across diverse connectivity environments. The system can use a combined chipset/PCB supporting both NB-IoT and LoRaWAN protocols. The system can be configured to use NB-IoT where available and LoRaWAN as redundancy via node and satellite backhaul for remote deployment, dependent on economics. Whichever protocol is cheapest in a given location may be prioritized before other factors.

Switching between communication modes can be automated. NB-IoT may require confirmation of data packet receipt; if no confirmation is received, the system can switch to LoRaWAN, which does not require confirmation to avoid download congestion. The data set may be binary, meaning no split backhaul delivery is required or implemented.

The tiered connectivity approach—with NB-IoT primary, LoRaWAN fallback, drive-by collection tertiary, and store-and-forward last resort—may be specifically designed to maintain 90%+ data completeness for carbon credit issuance. This system may be designed from first principles around the specific commercial requirement of meeting Verra and Gold Standard Tier 3 metered methodology requirements across diverse connectivity environments in developing markets.

The LoRaWAN implementation may use LoRaWAN Class B, with optionality to switch to Class A if needed for firmware updates, key updates, or other management functions. All security and protocols can be built into LoRaWAN as common industry standard with significant product support and optionality.

The payload may be less than 50 bytes for the required communication, transmitted once per day during an allotted timeslot based on application layer protocols. Data can be encrypted and authenticated at the application layer. No acknowledgement is sent to reduce download congestion. Verification at the application layer can determine whether data is absent; where data is absent, a “fetch” may occur about once a week to retrieve relevant missing information. Onboard memory may hold a minimum of 90 days of data.

Duty cycling may be fundamental to the device and architecture. The transmission architecture for LoRaWAN may maintain 1% channel occupancy per device per hour in certain locations.

The telemetry system can communicate data once per day during an allotted timeslot based on application layer architecture. Data may be signed by the device with up to 200 days of data held onboard for verification purposes. A handshake can occur at the gateway with verification and authentication upon receipt at the application layer.

The telemetry payload structure may be designed to be compact while conveying all necessary information. An exemplary payload structure of approximately 22 bytes can include the following fields: Device ID (unique unit identifier, 4 bytes), Date (transmission date, 2 bytes), Sequence number (gap detection counter, 2 bytes), Cooktop on-time (minutes active today, 2 bytes), Cooking events (number of on/off cycles, 1 byte), Cooktop energy (Wh consumed by cooktop, 2 bytes), Battery state of health (percentage 0-100, 1 byte), Solar input Wh (energy harvested today, 2 bytes), Device uptime (hours operational today, 1 byte), Fault flags (bitmask of fault conditions, 1 byte), and/or Checksum/hash (data integrity verification, 4 bytes). This payload size may be suitable for both NB-IoT and LoRaWAN protocols.

The message type can be binary with a defined field structure, big-endian encoding, and CRC32 integrity check (4 bytes). Optionally, HMAC-SHA256 may be used if standards require this level of integrity verification (an additional 32 bytes, still within payload capability). The message may be wrapped automatically by LoRaWAN or NB-IoT protocol envelopes that handle encryption, authentication, and routing transparently.

Device communication outside the daily cadence may occur for retransmission requests, fault codes (battery, device, or panel failures), abnormal behavior or device tamper detection, configuration or firmware updates, initial deployment and commissioning, and/or just before carbon verification dates. Substantially all computing may be performed in the cloud, with some processing optionally occurring at the gateway.

The telemetry system may capture and record various categories of data displayed in time series graphs. User data can include whatever the top stove glass LEDs show, which can also be obtained remotely. Internal data can include wireless network information, the unit's internal temperature versus time, battery charge level (percentage), solar charging state (power in), system power consumption (power out), current fridge temperature, target fridge temperature, stove power setting (1-9), and/or stove errors (such as no pot detection).

Additional internal data may include the state of the UI (e.g., fridge/stove lock enabled, hot icon displayed, etc.), internal system temperatures (e.g., with optional humidity monitoring), subsystem state and errors (e.g., fridge, stove, battery, etc.), and/or fan control data (e.g., fan speed target, current fan speed). The system may also capture additional battery diagnostics such as individual cell voltages, fridge operating mode (e.g., Eco vs. full blast), and/or overall system data (memory usage, signal strength).

If a GPS antenna is pointed at the sky, GPS location data may be obtained. SIM remote control and diagnostics may also be available, optionally along with 2G-3G-4G-5G/WiFi connectivity diagnostics (signal strength, network name, etc.) on units where the Terrestial network or WiFi card is installed (the “Gateway-less” option).

From the captured data, various events can be derived and classified. For example, if the stove is ON for greater than 15 minutes, that may be counted as a meal. If the fridge temperature drops, then it can be inferred that the door has been opened. These derived events can provide valuable usage insights without requiring continuous high-bandwidth monitoring.

The main areas measured by the telemetry system may include, but are not limited to: (1) usage of the unit (on, off, duration, frequency); (2) self-diagnosis capability; (3) performance (thermal, temperature, etc.); (4) location of device (asset tracking); and/or (5) ability to turn the device on/off for pay-as-you-cook capability.

The pay-as-you-cook capability may enable a business model where users pay for cooking time or energy usage rather than purchasing the appliance outright. This capability can be enabled by the remote monitoring and control features of the telemetry system.

The telemetry system may employ adaptive data collection granularity, varying the sampling rate based on appliance state. For example, during active cooking, samples may be taken at 30-second intervals to capture detailed usage patterns, while during deep idle periods, samples may be taken at 30-minute intervals to conserve power. This variable-granularity data is accumulated into a daily summary that can meet carbon credit methodology requirements while remaining within LoRaWAN payload constraints.

The adaptive granularity approach may represent a non-obvious design choice that resolves the tension between three competing requirements: rich evidence for carbon verification, minimal power consumption for a solar appliance, and constrained payload size for LoRaWAN transmission. Serving all three requirements simultaneously may provide a technical advantage over conventional approaches that prioritize only one or two of these requirements.

Transmission frequency in low power states can also be built into firmware. Below a specific battery level, the device may not transmit or may have limited transmission. This architecture can be built alongside compliance requirements for credit verification. The power management may be built on battery management power tiers with conditions for device and communication management.

Transmission may not depend on appliance state (e.g., active cooking vs. idle), although it may be most power efficient to transmit when the device is already in a state of heavy load rather than sleep state. This consideration can enable optimization of overall power consumption while maintaining data completeness.

The memory buffer 1416 may be implemented using EEPROM, Flash Memory, or FRAM (Ferroelectric Random Access Memory). FRAM may be preferred if cost effective, otherwise EEPROM may be used. The buffer may be implemented as a circular buffer with transmission confirmation protections. Data that is unconfirmed to be transmitted may be the last data to be erased based on aging. Data outside the current carbon crediting period no longer be relevant for carbon crediting purposes. For example, if crediting every six months, data over 200 days old may be irrelevant.

At 22 bytes per day, even a small 32 kB memory can provide approximately 3 years of data offline with limited or no overwrite. Since carbon is credited on a 6-monthly basis, the storage capacity may be more than adequate.

Upload can be triggered by: (1) scheduled daily window upload; (2) if unconfirmed records exceed a threshold percentage, then out-of-sequence transmission may occur; (3) fault alert; and/or (4) retransmission request.

If memory approaches capacity, automation can trigger a transmission when 90% capacity is reached. On successful transmission and confirmation, confirmed data may be wiped. If no confirmation is achieved, the oldest data outside the credit window may be overwritten as it has no creditable value. This event can be logged to indicate when data loss occurred for transparency purposes. A buffer overflow can also be logged at the date so that the timing of any data loss can be identified. Confirmation on a single data set may implicitly confirm all previous relevant data if sequence continuity is verified, eliminating the need to confirm all previous data independently.

### Data Collection Methods

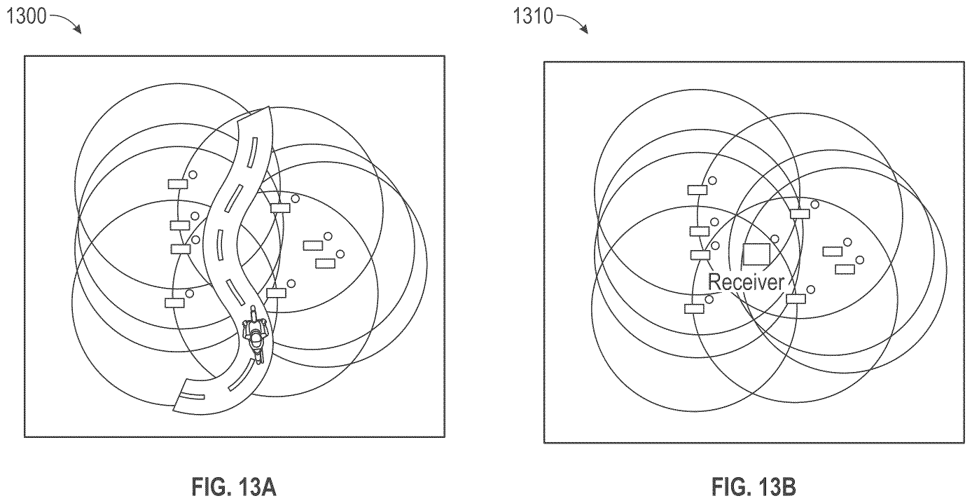

Data collection can include a drive-by data collection system, a static collection setup, or a combination thereof. Shown in FIG. 13A, drive-by collection 1300 can offer broader coverage which can be ideal for gathering data over large areas. A driver can periodically travel through the area carrying a receiver which can pick up data from all units within ~1-2 Km.

Shown in FIG. 13B, static collection 1310 can provide the possibility of continuous, real-time monitoring at fixed locations. A receiver can be deployed in the vicinity of the portable household appliances, where it continuously collects and stores all data of interest. The data can then periodically be collected by USB or automatically uploaded if Internet access is available.

For drive-by collection, a portable LoRaWAN gateway may be used, implemented via an industry-standard handheld device or a smartphone with a dongle. For static collection, either an outdoor gateway powered by solar with backhaul optionality or an indoor gateway with a deployment partner that has power provisioning may be used, depending on availability and again with backhaul optionality.

The receiver can act as the gateway and collect, store, and forward data based on application layer protocols and backhaul options. Application layer protocols and the system can determine whether there is receipt of data at the device, but confirmation can be delayed to a future drive-by event or static collection event. Confirmation at a later stage can eliminate the need for immediate acknowledgement. The device can store data until confirmation is received.

Sequence numbering can provide the solution for duplication detection at the application layer. Data may be tagged as uploaded at multiple levels: (1) at the application layer, Device ID and sequence number may be logged; (2) at the device, when explicit confirmation is given (if using NB-IoT, confirmed on delivery; if using LoRaWAN, on weekly acknowledgment; if unconfirmed, the data may stay in the buffer as transmitted and unconfirmed); and/or (3) at the drive-by gateway, once a collected record has been successfully uploaded to the application layer/platform.

Data upload may be immediate or batched depending on the communication technology. If the drive-by option is used, data may be batched with protocols developed for this purpose. Drive-by data collection may utilize Class B LoRaWAN capability and may use beacon-triggered transmission to power up the communication, avoiding the requirement for the device to be always on. Alternatively, a scheduled collection window or other method may be used.

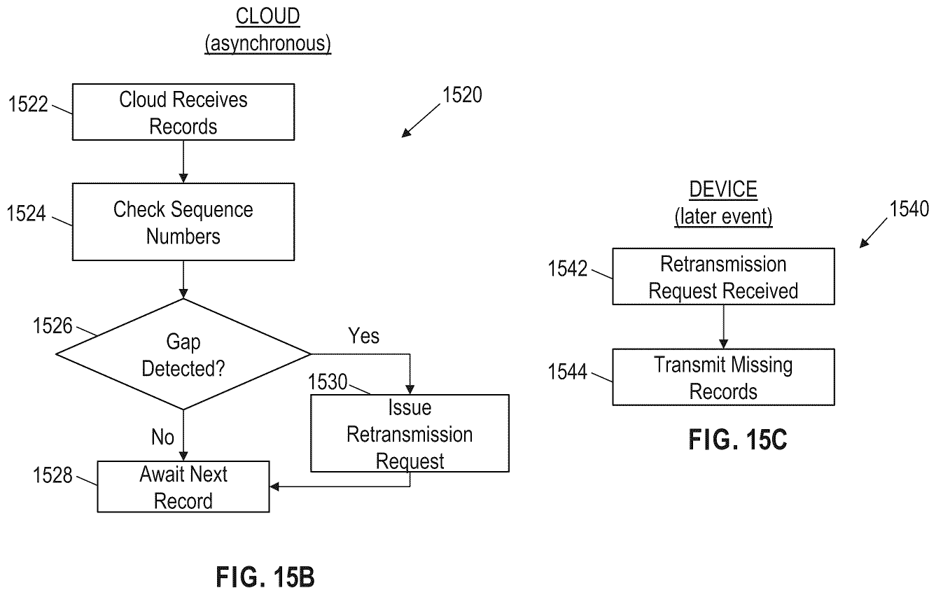

FIGS. 15A-15C illustrate process diagrams 1500, 1520, 1540 for data collection and transmission in the portable household appliance. These flowcharts depict the device-side operations, cloud-side operations, and device response to retransmission requests.

FIG. 15A illustrates the device-side data collection process 1500. At block 1502 (Daily Schedule or Event Trigger), the process can begin based on a scheduled daily transmission window or an event that triggers data transmission. The daily schedule can ensure regular data reporting while event triggers enable responsive reporting of faults or abnormal conditions.

At block 1504 (Collect Metrics & Create Record), the telemetry processor 1414 can collect metrics from the various subsystems (e.g., cooktop, cooler, battery, solar input) and creates a data record. The record can include the fields described in the telemetry payload structure, such as Device ID, Date, Sequence number, Cooktop on-time, cooking events, Cooktop energy, Battery state of health, Solar input, Device uptime, Fault flags, and/or Checksum/hash.

At block 1506 (Store Record in Buffer), the created record can be stored in the memory buffer 1416. This can ensure that data is preserved locally even if transmission fails. The buffer may employ a circular buffer design with transmission confirmation protections.

At block 1508 (Attempt NB-IoT Send), the communication module 1418 can attempt to transmit the record via NB-IoT, which may be the primary communication protocol. NB-IoT may be preferred where available due to its cellular connectivity and confirmation capabilities.

At decision block 1510 (Confirmation Received?), the system can check whether confirmation of successful transmission was received. If confirmation is received (Yes path), the process can proceed to block 1512 (Mark Record Confirmed). If no confirmation is received (No path), the process can proceed to block 1514 (Send via LoRaWAN).

At block 1512 (Mark Record Confirmed), the record can be marked as confirmed in the buffer. Confirmation may implicitly confirm prior unconfirmed records when sequence continuity is verified. This can eliminate the need to confirm each record independently.

At block 1514 (Send via LoRaWAN), the record can be transmitted via LoRaWAN as a fallback protocol. LoRaWAN may not require confirmation, e.g., to avoid download congestion. Verification can occur at the application layer to determine whether data is absent.

At block 1516 (End), the device-side transmission process can conclude and await the next scheduled transmission or event trigger.

FIG. 15B illustrates the cloud-side (asynchronous) data processing 1520. This process can occur independently of the device-side process and may handle incoming data from multiple devices.

At block 1522 (Cloud Receives Records), the cloud MRV platform 1428 can receive data records from one or more portable household appliances via the gateway 1424.

At block 1524 (Check Sequence Numbers), the cloud platform can check the sequence numbers of received records to detect any gaps in the data stream. Sequence numbering may be the solution for detecting missing data and preventing duplication at the application layer.

At decision block 1526 (Gap Detected?), the system can determine whether any sequence numbers are missing. If a gap is detected (Yes path), the process can proceed to block 1528 (Issue Retransmission Request). If no gap is detected (No path), the process can proceed to block 1530 (Await Next Record).

At block 1528 (Issue Retransmission Request), the cloud platform may issue a request for the missing data. This request can be transmitted to the device at the next communication opportunity. For example, a “fetch” may occur about once per week to retrieve relevant missing information.

At block 1530 (Await Next Record), the cloud platform can continue monitoring for incoming records from devices. The system may maintain about 90%+ data completeness for carbon credit issuance through this continuous monitoring and gap detection process.

FIG. 15C illustrates the device response to a retransmission request 1540. This process can occur when the device receives a request from the cloud to retransmit missing data.

At block 1542 (Retransmission Request Received), the device may receive a retransmission request from the cloud platform. This request can identify which records are missing based on sequence number gaps.

At block 1544 (Transmit Missing Records), the device can retrieve the requested records from the memory buffer 1416 and transmit them. Since the device stores up to 200 days of data onboard, missing records can be retrieved for an extended period after the original transmission attempt. This capability may ensure high data completeness even in areas with intermittent connectivity.

### Computing Device

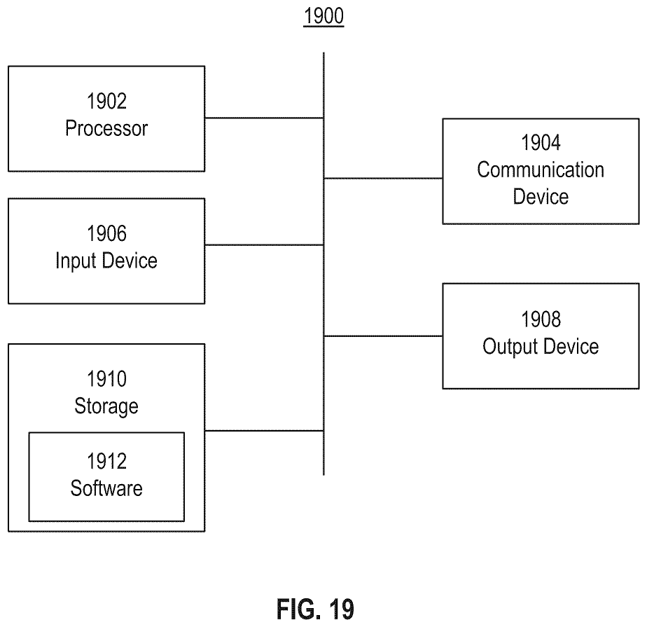

FIG. 19 illustrates a computing device 1900 that may be used to implement aspects of the telemetry processor 1414 or other computational components of the portable household appliance. Computing device 1900 can be a host computer connected to a network. Computing device 1900 can be a client computer or a server. As shown in FIG. 19, computing device 1900 can be any suitable type of microprocessor-based device, such as a personal computer, workstation, server, or handheld computing device (portable electronic device) such as a phone or tablet. The computing device 1900 can include a processor 1902, a communication device 1904, an input device 1906, an output device 1908, storage 1910, and software 1912.

The processor 1902 executes instructions stored in the software 1912 to perform the data collection, buffering, and communication functions described herein. The communication device 1904 may implement the multi-mode radio functionality for NB-IoT and LoRaWAN communication. The input device 1906 may receive signals from the various sensors in the cooktop subsystem 1404, cooler subsystem 1406, and battery/BMS 1408. The output device 1908 may control the digital interface 1600 or other user-facing elements. The storage 1910 may implement the memory buffer 1416 for storing telemetry records.

Input device 1906 can be any suitable device that provides an input, such as a touch screen, keyboard or keypad, mouse, or voice-recognition device. Output device 1908 can be any suitable device that provides output, such as a display, touch screen, haptics device, and/or speaker.

Storage 1910 can be any suitable device that provides storage, such as an electrical, magnetic, or optical memory, including a RAM, cache, hard drive, or removable storage disk. Communication device 1904 can include any suitable device capable of transmitting and receiving signals over a network, such as a network interface chip or device. The components of the computer can be connected in any suitable manner, such as via a physical bus or wirelessly.

Software 1912, which can be stored in storage 1910 and executed by processor 1902, can include, for example, the programming that embodies the functionality of the present disclosure (e.g., as embodied in the devices as described above).

Software 1912 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 1910, that can contain or store programming for use by or in connection with an instruction execution system, apparatus, or device.

Software 1912 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Computing device 1900 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computing device 1900 can implement any operating system suitable for operating on the network. Software 1212 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

### EMBODIMENTS

The following embodiments are exemplary and are not intended to limit the scope of the disclosure provided herein.
Embodiment 1. A portable household appliance, comprising: a housing containing: an induction cooktop; a cooler; a charging unit comprising at least one outlet configured for powering other household devices; and a battery configured for powering the induction cooktop, the cooler, and the charging unit, wherein the portable household appliance is configured to be carried by one or two people.
Embodiment 2. The portable household appliance of embodiment 1, wherein the housing comprises one or more handles for carrying the portable household appliance.
Embodiment 3. The portable household appliance of embodiment 1 or 2, wherein the at least one outlet of the charging unit comprises a socket configured for connecting with a 12-V inverter to power AC appliances.
Embodiment 4. The portable household appliance of any one of embodiments 1-3, wherein the at least one outlet of the charging unit comprises a USB-A outlet.
Embodiment 5. The portable household appliance of any one of embodiments 1-4, wherein the at least one outlet of the charging unit comprises a USB-C outlet.
Embodiment 6. The portable household appliance of any one of embodiments 1-5, wherein the charging unit is located on a side of the housing.
Embodiment 7. The portable household appliance of any one of embodiments 1-6, wherein a top portion of the housing comprises a lid for the cooler.
Embodiment 8. The portable household appliance of embodiment 7, wherein the induction cooktop is on the top portion of the housing adjacent to the lid of the cooler.
Embodiment 9. The portable household appliance of any one of embodiments 1-6, wherein a side portion of the housing comprises a door for the cooler.
Embodiment 10. The portable household appliance of embodiment 9, wherein the induction cooktop is positioned above the cooler in the housing.
Embodiment 11. The portable household appliance of any one of embodiments 1-10, wherein the induction cooktop is detachable from the housing.
Embodiment 12. The portable household appliance of embodiment 11, wherein the induction cooktop comprises a separate battery for powering the induction cooktop when detached from the housing.
Embodiment 13. The portable household appliance of embodiment 11, wherein the induction cooktop is connectable to the charging unit for powering the induction cooktop when detached from the housing.
Embodiment 14. The portable household appliance of embodiment 11, wherein the induction cooktop is connected to the battery contained within the housing such that the induction cooktop remains powered when detached from the housing.
Embodiment 15. The portable household appliance of any one of embodiments 1-14, wherein the induction cooktop comprises a digital interface.
Embodiment 16. The portable household appliance of any one of embodiments 1-15, comprising a solar plug configured to connect to a solar panel for charging the battery.
Embodiment 17. The portable household appliance of any one of embodiments 1-16, comprising an AC plug configured to connect to an AC power source for charging the battery.
Embodiment 18. The portable household appliance of any one of embodiments 1-15, wherein the battery comprises at least one prismatic cell.
Embodiment 19. The portable household appliance of any one of embodiments 1-18, wherein the battery has a wattage between 1.3-2.6 KW.
Embodiment 20. The portable household appliance of any one of embodiments 1-19, wherein the battery is configured to power the induction cooktop, the cooler, and the charging unit for at least one hour when the portable household appliance is not connected to a power source.
Embodiment 21. The portable household appliance of any one of embodiments 1-20, wherein the housing is composed of at least one of stainless steel, aluminum, plastic, polymer, steel, glass, bamboo, and ceramic glass.
Embodiment 22. The portable household appliance of any one of embodiments 1-21, wherein the housing is rectangular in shape.
Embodiment 23. The portable household appliance of any one of embodiments 1-22, wherein a height of the housing is between 300-1000 mm.
Embodiment 24. The portable household appliance of any one of embodiments 1-23, wherein a length of the housing is between 500 -1500 mm.
Embodiment 25. The portable household appliance of any one of embodiments 1-24, wherein a width of the housing is between 250-800 mm.
Embodiment 26. The portable household appliance of any one of embodiments 1-25, comprising: at least one memory; and at least one processor configured to collect usage data from the portable household appliance and store the usage data in the at least one memory.
Embodiment 27. The portable household appliance of embodiment 26, wherein the usage data comprises at least one of a total amount of electrical power used and a number of the other household devices charged.
Embodiment 28. The portable household appliance of embodiment 26 or 27, wherein the at least one processor is configured to enable access to the usage data stored in the at least one memory by an external data receiver.
Embodiment 29. The portable household appliance of embodiment 28, wherein the at least one processor and the external data receiver are configured to communicate over a long-range, low-power communication mode (LoRa).
Embodiment 30. The portable household appliance of embodiment 28 or 29, wherein the external data receiver is static, such that the usage data is collected continuously.
Embodiment 31. The portable household appliance of embodiment 28 or 29, wherein the external data receiver is portable, such that the usage data is collected periodically.
Embodiment 32. The portable household appliance of any one of embodiments 26-31, comprising a multi-mode communication module configured to transmit the usage data using a plurality of communication protocols.
Embodiment 33. The portable household appliance of embodiment 32, wherein the plurality of communication protocols comprises NB-IoT and LoRaWAN.
Embodiment 34. The portable household appliance of embodiment 33, wherein the multi-mode communication module is configured to use NB-IoT as a primary communication protocol and LoRaWAN as a fallback communication protocol.
Embodiment 35. The portable household appliance of any one of embodiments 32-34, wherein switching between communication protocols is automatic based on confirmation of data packet receipt.
Embodiment 36. The portable household appliance of any one of embodiments 26-35, wherein the at least one memory comprises a circular buffer configured to store telemetry records with transmission confirmation protections.
Embodiment 37. The portable household appliance of any one of embodiments 26-36, wherein the at least one memory is configured to store at least 90 days of usage data.
Embodiment 38. The portable household appliance of any one of embodiments 26-37, wherein the usage data comprises a telemetry payload including one or more fields selected from a list consisting of: device ID, date, sequence number, cooktop on-time, cooking events, cooktop energy consumption, battery state of health, solar energy input, device uptime, fault flags, and a checksum.
Embodiment 39. The portable household appliance of any one of embodiments 26-38, wherein the telemetry payload is less than 50 bytes.
Embodiment 40. The portable household appliance of any one of embodiments 26-39, wherein the at least one processor is configured to transmit the usage data once per day during a scheduled transmission window.
Embodiment 41. The portable household appliance of any one of embodiments 26-40, wherein the usage data comprises a multi-dimensional usage signature derived from one or more of simultaneous cooktop energy draw, cooler compressor cycling, battery charge and discharge patterns, and solar input correlation.
Embodiment 42. The portable household appliance of any one of embodiments 26-41, wherein the at least one processor is configured to employ adaptive data collection granularity for varying sampling rate based on appliance state.
Embodiment 43. The portable household appliance of embodiment 42, wherein the at least one processor is configured to sample at about 30-second intervals during active cooking and at about 30-minute intervals during idle periods.
Embodiment 44. The portable household appliance of any one of embodiments 26-43, further comprising a GPS module for location tracking.
Embodiment 45. The portable household appliance of any one of embodiments 26-44, wherein the at least one processor is configured to enable pay-as-you-cook functionality through remote monitoring and control.
Embodiment 46. The portable household appliance of any one of embodiments 26-45, wherein the at least one processor is configured to derive events from the usage data, including meal detection when the cooktop is on for greater than a threshold duration.
Embodiment 47. The portable household appliance of any one of embodiments 26-46, wherein the at least one processor is configured to detect cooler door opening based on temperature changes.
Embodiment 48. The portable household appliance of any one of embodiments 1-47, comprising: a first vent for cool air intake for the induction cooktop; a second vent for cool air intake for the cooler; a third vent for hot air outflow from the induction cooktop; and a fourth vent for hot air outflow from the cooler.
Embodiment 49. The portable household appliance of embodiment 48, wherein the vents are operably coupled to fans for active air circulation.
Embodiment 50. The portable household appliance of any one of embodiments 1-49, comprising a digital interface including: a cooktop control section; a cooler control section; an energy input/output/storage indicator section; and safety conditions and warning indicators.
Embodiment 51. The portable household appliance of embodiment 50, wherein the digital interface is configured to differentiate between user errors and system faults and provides guidance supporting corrective action.
Embodiment 52. The portable household appliance of any one of embodiments 50-51, wherein the digital interface is designed for usability across varying literacy levels, languages, and cultural settings.
Embodiment 53. The portable household appliance of any one of embodiments 1-52, further comprising integrated lighting with multiple brightness levels.
Embodiment 54. The portable household appliance of embodiment 53, wherein the multiple brightness levels comprise approximately 370, 240, and 30 lumens.
Embodiment 55. A kit, comprising: the portable household appliance of any one of embodiments 1-54; and at least one pot configured for use with the induction cooktop and sized to fit on the induction cooktop.
Embodiment 56. The kit of embodiment 55, wherein the at least one pot is sized to fit within the cooler.
Embodiment 57. The kit of embodiment 55 or 56, comprising at least one solar panel for powering the portable household appliance.
Embodiment 58. The kit of embodiment 57, comprising at least one cable for connecting the at least one solar panel to the portable household appliance.
Embodiment 59. A method of collecting and transmitting usage data from a portable household appliance, comprising: collecting metrics from a cooktop subsystem, a cooler subsystem, and a battery of the portable household appliance; creating a telemetry record including the collected metrics; storing the telemetry record in a memory buffer; attempting to transmit the telemetry record via a primary communication protocol; if confirmation of transmission is received, marking the telemetry record as confirmed; and if confirmation of transmission is not received, transmitting the telemetry record via a fallback communication protocol.
Embodiment 60. The method of embodiment 59, wherein the primary communication protocol is NB-IoT and the fallback communication protocol is LoRaWAN.
Embodiment 61. The method of any one of embodiments 59-60, further comprising: at a cloud platform, checking sequence numbers of received telemetry records; if a gap in sequence numbers is detected, issuing a retransmission request; and at the portable household appliance, transmitting missing telemetry records in response to the retransmission request.
Embodiment 62. The method of any one of embodiments 59-61, wherein marking the telemetry record as confirmed implicitly confirms prior unconfirmed records when sequence continuity is verified.
Embodiment 63. The method of any one of embodiments 59-62, further comprising: varying a sampling rate for collecting metrics based on an appliance state; sampling at a first rate during active cooking; and sampling at a second rate during idle periods, wherein the first rate is higher than the second rate.
Embodiment 64. The method of any one of embodiments 59-63, wherein the telemetry record comprises a multi-dimensional usage signature derived from simultaneous cooktop energy draw, cooler compressor cycling, battery charge and discharge patterns, and solar input correlation, and wherein the method further comprises transmitting the multi-dimensional usage signature to a carbon credit verification system.

### Definitions

As used herein, the singular forms “a”, “an”, and “the” include the plural reference unless the context clearly dictates otherwise.

Reference to “about” a value or parameter herein includes (and describes) variations that are directed to that value or parameter per se. For example, description referring to “about X” includes description of “X”.

It is understood that aspects and variations of the invention described herein include “consisting of” and/or “consisting essentially of” aspects and variations.

When a range of values or values is provided, it is to be understood that each intervening value between the upper and lower limit of that range, and any other stated or intervening value in that stated range, is encompassed within the scope of the present disclosure. Where the stated range includes upper or lower limits, ranges excluding either of those included limits are also included in the present disclosure.

The section headings used herein are for organization purposes only and are not to be construed as limiting the subject matter described.

Finally, it is to be understood that features and preferences described in relation to “embodiments” are distinct preferences and are not limited only to that particular embodiment; they may be freely combined with features from other embodiments, where technically feasible, and may form preferred combinations of features. The description is presented to enable one of ordinary skill in the art to make and use the invention and is provided in the context of a patent application and its requirements. Various modifications to the described embodiments will be readily apparent to those persons skilled in the art and the generic principles herein may be applied to other embodiments. Thus, the present invention is not intended to be limited to the embodiment shown but is to be accorded the widest scope consistent with the principles and features described herein.

The entire disclosure of the patents and publications referred in this application are hereby incorporated herein by reference for all purposes. To the extent that any reference incorporated by reference conflicts with the instant disclosure, the instant disclosure shall control.

### Conclusion

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims.

What is claimed is:

1. A portable household appliance, comprising:
a housing containing:
an induction cooktop;
a cooler;
a charging unit comprising at least one outlet configured for powering other household devices; and
a battery configured for powering the induction cooktop, the cooler, and the charging unit,
wherein the portable household appliance is configured to be carried by one or two people.

2. The portable household appliance of claim 1, wherein the housing comprises one or more handles for carrying the portable household appliance.

3. The portable household appliance of claim 1, wherein the at least one outlet of the charging unit comprises a socket configured for connecting with a 12-V inverter to power AC appliances.

4. The portable household appliance of claim 1, wherein the at least one outlet of the charging unit comprises a USB-A outlet and/or a USB-C outlet.

5. The portable household appliance of claim 1, wherein a top portion of the housing comprises a lid for the cooler.

6. The portable household appliance of claim 5, wherein the induction cooktop is on the top portion of the housing adjacent to the lid of the cooler.

7. The portable household appliance of claim 1, wherein the induction cooktop is detachable from the housing.

8. The portable household appliance of claim 1, wherein the induction cooktop comprises a digital interface.

9. The portable household appliance of claim 1, comprising a solar plug configured to connect to a solar panel for charging the battery and/or an AC plug configured to connect to an AC power source for charging the battery.

10. The portable household appliance of claim 1, wherein the battery has a wattage between 1.3-2.6 KW.

11. The portable household appliance of claim 1, wherein the battery is configured to power the induction cooktop, the cooler, and the charging unit for at least one hour when the portable household appliance is not connected to a power source.

12. The portable household appliance of claim 1, wherein a height of the housing is between 300-1000 mm, a length of the housing is between 500 -1500 mm, and/or a width of the housing is between 250-800 mm.

13. The portable household appliance of claims 1, comprising:
at least one memory; and
at least one processor configured to collect usage data from the portable household appliance and store the usage data in the at least one memory.

14. The portable household appliance of claim 13, wherein the usage data comprises at least one of a total amount of electrical power used and a number of the other household devices charged.

15. The portable household appliance of claim 13, wherein the at least one processor is configured to enable access to the usage data stored in the at least one memory by an external data receiver.

16. The portable household appliance of claim 15, wherein the at least one processor and the external data receiver are configured to communicate over a long-range, low-power communication mode (LoRa).

17. The portable household appliance of claim 15, wherein the external data receiver is static, such that the usage data is collected continuously.

18. The portable household appliance of claim 15, wherein the external data receiver is portable, such that the usage data is collected periodically.

19. A kit, comprising:
the portable household appliance of any claim 1; and
at least one pot configured for use with the induction cooktop and sized to fit on the induction cooktop and within the cooler.

20. The kit of claim 19, comprising at least one solar panel for powering the portable household appliance, and at least one cable for connecting the at least one solar panel to the portable household appliance.
